(19) United States
(12) Patent Application Publication
(10) Pub. No.: US 2026/0279625 A1
(43) Pub. Date: Sep. 17, 2026

(54) PTC THERMISTOR

(71) Applicant: TOKYO COSMOS ELECTRIC CO., LTD., Kanagawa (JP)

(72) Inventors: Hajime MIYAHARA, Kanagawa (JP); Hironori ITO, Kanagawa (JP)

(21) Appl. No.: 19/166,756

(22) PCT Filed: Mar. 4, 2024
(86) PCT No.: PCT/JP2024/007957

§ 371 Date: Sep. 18, 2025

(30) Foreign Application Priority Data
Mar. 23, 2023 (JP) 2023-046588

(51) Int. Cl. H01C 7/02

(52) U.S. Cl. CPC H01C 7/027

(57) ABSTRACT

One problem addressed by this invention is to provide a PTC resistor having a resistance value that increases quickly and easily after a designated temperature is reached and that reaches a high value after the temperature rise. The problem is resolved by a PTC resistor that comprises conductive particles, a naturally derived wax, and a binder resin.

### TECHNICAL FIELD

The present disclosure relates to a PTC resistor.

### BACKGROUND ART

To remove frost or dew adhering to a door mirror of an automobile or the like, a heater may be installed on the back surface of the mirror. A planar heating element having positive temperature coefficient (PTC) characteristics, which does not require an expensive temperature control apparatus, is widely used as such a heater.

A planar heating element having PTC characteristics typically includes a pair of electrodes and a resistor having PTC characteristics (also referred to as a “PTC resistor” in the present specification) disposed between the electrodes. A resistor including a crystalline resin and conductive particles is known as the PTC resistor (for example, PTL 1). In the planar heating element including such a PTC resistor, when a voltage is applied between the electrodes, electricity is conducted through the PTC resistor, causing its temperature to rise. Meanwhile, as the temperature of the planar heating element (PTC resistor) rises, the crystalline resin included therein thermally expands, widening the distance between the conductive particles and increasing the resistance value. The resistance value then rapidly increases in the vicinity of the softening temperature or the melting point of the crystalline resin, making it difficult for electricity to be conducted. Therefore, in the planar heating element, the temperature is controlled not to increase to a certain level or higher.

### CITATION LIST

### Patent Literature

### PTL 1

Japanese Patent Application Laid-Open No. 2012-227081

### SUMMARY OF INVENTION

### Technical Problem

Conventionally known PTC resistors using a crystalline resin as the binder have had the problem such that the thermal expansion during temperature rise is still not sufficient, and even when the temperature reaches a certain temperature, it takes time for the resistance value to increase. In addition, it is also required to further increase the resistance value of the PTC resistor after the temperature rise.

An object of the present disclosure is to provide a PTC resistor whose resistance value increases in a short time after the temperature of the PTC resistor reaches a certain temperature, and whose resistance value after the temperature rise is high.

An embodiment of the present disclosure provides a PTC resistor that includes: a conductive particle; a natural wax; and a binder resin.

### Advantageous Effects of Invention

The present disclosure can obtain a PTC resistor whose resistance value increases in a short time after the temperature of the PTC resistor reaches a certain temperature, and whose resistance value after the temperature rise is high.

### DESCRIPTION OF EMBODIMENTS

In the present specification, a numerical range indicated by “to” means a numerical range including the numerical values indicated before and after “to”.

As described above, in a conventional PTC resistor, the PTC characteristics are imparted by mainly using thermal expansion or recrystallization of the crystalline resin. However, with the method, the rate of increase in the resistance value after the temperature reaches a certain temperature is low, and the degree of increase in the resistance value is also small. A PTC resistor according to the present disclosure meanwhile contains conductive particles, a binder resin, and a natural wax. In the PTC resistor, the natural wax melts in the vicinity of a melting point thereof when the temperature rises. The volume increase due to the melting of the natural wax is significantly larger than the volume increase of a general resin, and occurs in a short time. Therefore, when the temperature of the PTC resistor reaches a predetermined temperature, the resistance value increases in a short time, and the degree of increase in the resistance value is also very large. The PTC resistor having such excellent PTC characteristics can be suitably used for various planar heating elements and the like.

Hereinafter, each component in the PTC resistor according to the present disclosure will be described.

### (Natural Wax)

In the present specification, the wax refers to an organic substance that is solid or semi-solid at room temperature (25° C.) and melts without decomposing by heating. The natural wax refers to a plant-based wax derived from a plant or an animal-based wax derived from an animal. In addition, the plant-based wax refers to a wax using a plant as a raw material. The animal-based wax refers to a wax using an animal as a raw material. The PTC resistor may contain only one type of natural wax or two or more types of natural wax. The type of natural wax contained in the PTC resistor is not limited, but the PTC resistor is usually required to increase a resistance value at 40° C. or higher and 100° C. or lower. Therefore, the melting point of the natural wax is preferably 40° C. or higher and 100° C. or lower, and more preferably 50° C. or higher and 90° C. or lower.

The wax ester component contained in the natural wax is preferably 10% by mass or more. When the wax ester component is 10% by mass or more, the melting point of the natural wax is more likely to fall within the above-described range. In addition, the melting in the vicinity of the melting point is more likely to progress in a shorter time.

Here, the wax ester component refers to an ester formed by bonding a higher fatty acid and a higher monovalent alcohol to each other at a ratio of 1:1. The wax ester component is, for example, an ester of a higher fatty acid having 10 or more and 50 or less carbon atoms and a higher monovalent alcohol having 10 or more and 50 or less carbon atoms. The total number of carbon atoms constituting the wax ester component is preferably 20 or more and 100 or less, and more preferably 30 or more and 50 or less.

The natural wax may further contain a free saturated fatty acid (the above-described higher fatty acid) or a free alcohol (the above-described higher monovalent alcohol). The amount of the free saturated fatty acid is preferably 20% by mass or less based on the total mass of the natural wax. On the other hand, the amount of the free alcohol is more preferably 15% by mass or less based on the total mass of the natural wax.

In addition, the iodine value of the natural wax is preferably 80 or less, more preferably 30 or less, and still more preferably 25 or less. The iodine value represents the amount of unsaturated bonds in the hydrocarbon chains of the components contained in the natural wax. The iodine value in the natural wax, that is, the amount of unsaturated double bonds is preferably small. When the amount of unsaturated double bonds is large, the natural wax is difficult to be melted even when the temperature of the PTC resistor increases. That is, when the iodine value exceeds 80, the resistance value is difficult to increase during the temperature rise. On the other hand, when the iodine value is 80 or less, the natural wax is easily melted and the resistance value is easily increased when the temperature of the PTC resistor rises.

Examples of the plant-based wax, namely a type of natural wax, include candelilla wax, carnauba wax, rice wax, wood wax, and hydrogenated jojoba wax. Among these, carnauba wax, candelilla wax, and rice wax are preferable from the viewpoint of availability and ease of increasing the PTC ratio.

Examples of the animal-based wax, namely a type of natural wax, include beeswax and lanolin wax.

The amount of the natural wax in the PTC resistor is preferably 5% by mass or more and 50% by mass or less, and more preferably 7% by mass or more and 40% by mass or less. When the amount of the natural wax in the PTC resistor is 5% by mass or more, the resistance value of the PTC resistor when the temperature thereof rises is more likely to further increase. On the other hand, when the amount of the natural wax is 50% by mass or less, the amount of the conductive particles described below becomes relatively and sufficiently large, and the PTC characteristics of the PTC resistor are more likely to be further improved.

### (Binder Resin)

The binder resin may be any resin as long as it can bind the above-described natural wax and the conductive particles described below to each other or bind these components to a substrate or the like, but is preferably a resin that does not hinder the volume change upon melting of the above-described natural wax. In addition, the binder resin itself may also expand by the temperature rise to contribute to the increase in the resistance value of the PTC resistor. The PTC resistor may contain only one type of binder resin or two or more types thereof.

Examples of the binder resin include known thermoplastic resins. Specific examples the binder resin include thermoplastic polyurethane resins, polyester resins, polyacrylate resins, polysiloxane resins, halogenated vinyl resins, vinylidene resins, polyimide resins, phenoxy resins, polyether resins, polyketone resins, polyvinyl butyral resins, polyvinylpyrrolidone resins, polyacrylate resins, SEBS resins (styrene-ethylene-butylene-styrene copolymers) and hydrogenated products thereof, SEPS resins (styrene-ethylene-propylene-styrene copolymers) and hydrogenated products thereof, and the like. Among these, from the viewpoint of easily being deformable and not hindering the volume change of the above-described natural wax, a SEBS resin and a hydrogenated SEPS resin are preferable.

The amount of the binder resin in the PTC resistor according to the present aspect is preferably 5% by mass or more and 50% by mass or less, and more preferably 10% by mass or more and 40% by mass or less. When the amount of the binder resin in the PTC resistor is 5% by mass or more, it becomes easier to print the composition containing a conductive resin, the natural wax, and the binder resin, or the fixing property after printing is improved. Further, the strength of the PTC resistor is also more likely to be further increased. On the other hand, when the amount of the binder resin is 50% by mass or less, the amount of the conductive particles becomes relatively and sufficiently large, and the PTC characteristics are more likely to be further improved.

### (Conductive Particles)

The conductive particles may be any particles as long as the particles are conductive, but particles having a thermal expansion coefficient of 20×10⁻⁶/° C. or less are preferable, and particles having a thermal expansion coefficient of 6.0×10⁻⁶/° C. or less are more preferable. The thermal expansion coefficient of conductive particles can be specified from the type or the like of the conductive particles. The PTC resistor may include only one type of conductive particles or two or more types of conductive particles.

Examples of the conductive particles include carbon-based particles such as graphite, carbon black, carbon nanotubes, and graphene; and metal-based particles such as nickel powder, copper powder, silver powder, and tungsten powder. Among these, nickel powder, silver powder, tungsten powder, and graphite are preferable from the viewpoint of having high affinity with the above-described natural wax, the binder resin, and the like, and being difficult to precipitate in a composition for manufacturing the PTC resistor.

In addition, the conductive particles may have any shape, and for example, the conductive particles may be spherical, irregular, tubular, rod-shaped, flat, or crushed. The specific surface area of the conductive particles is preferably 5 m²/g or less. The specific surface area is a value measured by a gas adsorption method.

The size of the conductive particles is appropriately selected according to the type of conductive particles or the like. For example, when the conductive particles are spherical or substantially spherical, the average particle diameter thereof is preferably 30 μm or less, and more preferably 1 μm or more and 10 μm or less. When the average particle diameter is 30 μm or less, the PTC characteristics of the PTC resistor are more easily obtained. The average particle diameter is a value measured by a laser diffraction and scattering method and is a median value (D50) in a cumulative particle size distribution.

The content of the conductive particles in the PTC resistor is preferably 45% by mass or more and 80% by mass or less, and more preferably 50% by mass or more and 70% by mass or less. When the amount of the conductive particles in the PTC resistor is 45% by mass or more, the PTC characteristics are more likely to become more stable. On the other hand, when the amount of the conductive particles in the PTC resistor is 80% by mass or less, the amounts of the natural wax and the binder resin are increased, and the resistance value is more likely to further increase when the temperature is increased.

### (Others)

The PTC resistor may include other components as necessary in addition to the natural wax, the binder resin, and the conductive particles, as long as the object and effect of the present disclosure are not impaired. Examples of the other components include various additives such as antioxidants and flame retardants.

### (Method for Manufacturing PTC Resistor)

The PTC resistor according to the present disclosure can be manufactured by applying a composition (ink) containing the natural wax, the binder resin, the conductive particles, and, as necessary, a solvent, and heating and curing the composition.

The type of solvent is not limited as long as the natural wax, the binder resin, the conductive particles, and the like can be uniformly dissolved or dispersed in the solvent. However, the boiling point of the solvent is preferably 100° C. or higher, more preferably 100° C. to 330° C., and still more preferably 150° C. to 250° C. When the boiling point of the solvent is within the range, the storage stability of the composition and the like are improved, and further, the composition is easier to apply.

The solvent is appropriately selected according to the type of natural wax, the type of binder resin, and the like. Examples of the solvent include alcohols, ketones, esters, glycol esters, glycol ethers, ethers, aromatic hydrocarbons, and mixtures thereof. Terpineol, butyl carbitol acetate, tetralin, toluene, and mixtures thereof are preferable.

The amount of the solvent is appropriately selected according to the desired viscosity and the like of the composition (ink), but is usually preferably about 40 to 90 parts by mass, and more preferably 40 to 85 parts by mass, based on 100 parts by mass of the total amount of the composition (ink). When the amount of the solvent is within the range, the viscosity of the composition is more likely to fall within the desired range.

The preferred viscosity of the composition is appropriately selected depending on the method for forming the PTC resistor. For example, when the composition is printed by screen printing and is cured to obtain a PTC resistor, the viscosity of the composition is preferably 100 to 400 dPa-s. The viscosity is a value measured at 25° C. with a cylindrical type rotational viscometer (manufactured by RION Co., Ltd.). When the viscosity of the composition is within the range, the composition can be applied to a desired thickness, and a film can be formed uniformly.

The method for preparing the composition is not limited, and the natural wax, the resin binder, the conductive particles, and the solvent may be mixed at once. On the other hand, the resin binder and the solvent may be mixed first, and the natural wax and the conductive particles may be mixed thereafter.

The method for applying the composition is not limited, and examples thereof include screen printing, roll coating, and application using a dispenser.

In addition, examples of the method for curing the composition include a method of heating the composition to about 100° C. to 200° C. In this case, the heating time is preferably about 1 to 30 minutes. When the composition is heated to the above-described degree, the solvent in the composition is removed.

### (Usage of PTC Resistor)

The PTC resistor can be used as a planar heating element, for example, in combination with a pair of electrodes. When the temperature of the PTC resistor is increased to exceed a certain temperature, the resistance value increases in a short time, and the resistance value is extremely high as compared with the resistance value at normal temperature (25° C.). Therefore, the PTC resistor can be used for various usage. For example, the PTC resistor can be used as a heater such as an anti-fogging heater for a door mirror of an automobile, a defogging heater for an in-vehicle camera of an automobile rear-end collision prevention apparatus, a defogging heater for an in-vehicle millimeter wave radar of an automobile rear-end collision prevention apparatus, an antenna cover, a thermistor, a heater for preventing freezing of a pipeline, a floor heating system, a heating seat of a chair, and a handrail heating seat.

### EXAMPLES

Hereinafter, specific examples of the present invention will be described. It is noted that the scope of the present invention is not limited to these examples.

### 1. Preparation of Materials

The following compounds were prepared as materials for producing a PTC resistor.

### (Natural Wax (Plant-Based Wax))

Carnauba wax: melting point of 80° C. to 86° C., iodine value of 5 to 14, and wax ester component of 80% to 85% by mass
Candelilla wax: melting point of 68° C. to 73° C., iodine value of 5 to 14, and wax ester component of 80% to 85% by mass
Rice wax: melting point of 80° C., iodine value of 7.4, and wax ester component of 93% to 97% by mass

### (Plant Oil)

Castor oil: no melting point, iodine value of 83 to 89, and wax ester component of 1.7% (Others)
Conductive particles (artificial graphite (graphite), average particle diameter D50 of 4 μm, specific surface area of 5.0 m²/g, and thermal expansion coefficient of 6.0×10⁻⁶/° C.)
Binder resin: SEBS resin (styrene-ethylene-butylene-styrene block copolymer, TAFTEC 1913, manufactured by Asahi Kasei Corporation)
Solvent: terpineol

### 2. Production of Planar Heating Element Including PTC Resistor

A planar heating element including each PTC resistor was produced by the following procedure.

### Example 1

A varnish was prepared by mixing 4.9 parts by mass of the SEBS resin and 63.5 parts by mass of the organic solvent (terpineol) at 100° C. for 1 hour with a stirrer. The varnish, 11.5 parts by mass of natural wax (carnauba wax), and 20.1 parts by mass of the conductive particles (artificial graphite) were mixed and ground with a stirring grinding mixer to obtain an ink for screen printing.

A substrate including a pair of comb-shaped electrodes was prepared, and the above-described ink was printed between the comb-shaped electrodes by screen printing. The substrate was heated to 150° C. to produce a planar heating element including a desired PTC resistor.

### Example 2

A planar heating element including a PTC resistor was produced in the same manner as in Example 1, except that the type of natural wax was changed to candelilla wax.

### Example 3

A planar heating element including a PTC resistor was produced in the same manner as in Example 1, except that the type of natural wax was changed to rice wax.

### Comparative Example 1

A planar heating element including a PTC resistor was produced in the same manner as in Example 1, except that castor oil was used instead of the natural wax.

### [Evaluation]

The resistance value of each of the planar heating elements produced in Examples 1 to 3 and Comparative Example 1 was measured at 25° C. to 120° C. The maximum PTC ratio was calculated from the expression: (maximum resistance value)/(resistance value at 25° C.). The resistance value was measured by a two-terminal method or a four-terminal method. The results are shown in Table 1. In addition, the determination was made as follows: when the maximum PTC ratio was 100 times or more, it was determined as ∘; when the maximum PTC ratio was 2 times or more and less than 100 times, it was determined as Δ; and when the maximum PTC ratio was less than 2 times, it was determined as x.

TABLE 1

| | | | | | | Comparative |
|---|---|---|---|---|---|---|
| | | | Example 1 | Example 2 | Example 3 | Example 1 |
| Composition | Solvent | Type | Terpineol | Terpineol | Terpineol | Terpineol |
| | | Amount (parts | 63.5 | 63.5 | 63.5 | 63.5 |
| | | by mass) | | | | |
| | Binder resin | Type | SEBS | SEBS | SEBS | SEBS |
| | | Amount (parts | 4.9 | 4.9 | 4.9 | 4.9 |
| | | by mass) | | | | |
| | Natural wax | Type | Carnauba wax | Candelilla wax | Rice wax | — |
| | | Amount (parts | 11.5 | 11.5 | 11.5 | — |
| | | by mass) | | | | |
| | Plant oil | Type | — | — | — | Castor oil |
| | | Amount (parts | — | — | — | 11.5 |
| | | by mass) | | | | |
| | Conductive | Type | Artificial | Artificial | Artificial | Artificial |
| | Particles | | graphite | graphite | graphite | graphite |
| | | Amount (parts | 20.1 | 20.1 | 20.1 | 20.1 |
| | | by mass) | | | | |

| | | | | |
|---|---|---|---|---|
| Wax ester component in wax | 80-86 | 24-30 | 93-97 | 1.7 |
| (% by mass) | | | | |
| Melting point of wax (° C.) | 80-85 | 68-73 | 80 | — |
| Iodine value of wax | 5-14 | 10-22 | 7.4 | 83-89 |
| Maximum PTC ratio (25° C. or | 39000 | 9000 | 54000 | 0.8 |
| more 120° C. or less) | | | | |
| Determination | ∘ | ∘ | ∘ | x |

As shown in the above table, in the planar heating element using a vegetable oil (Comparative Example 1), the PTC ratio was not sufficiently increased, but in the planar heating elements using the PTC resistor containing a natural wax (Examples 1 to 3), the maximum PTC ratio was very high. In addition, in Examples 1 to 3, it was also confirmed that when the temperature was increased from room temperature (25° C.), the temperature stabilized in about one minute.

The present application is entitled to and claims the benefit of Japanese Patent Application No. 2023-046588, filed on Mar. 23, 2023, the disclosure of which including the specification and drawings is incorporated herein by reference in its entirety.

### INDUSTRIAL APPLICABILITY

The PTC resistor of the present disclosure has a resistance value that increases in a short time after the temperature of the PTC resistor reaches a certain temperature, and the resistance value is high after the temperature rise. Therefore, the PTC resistor is very useful for manufacturing various planar heating elements.

1. A PTC resistor comprising:
a conductive particles;
a natural wax; and
a binder resin.

2. The PTC resistor according to claim 1, wherein
the natural wax includes 10% by mass or more of a wax ester component.

3. The PTC resistor according to claim 1, wherein
the natural wax has an iodine value of 80 or less.
